(19) United States
(12) Patent Application Publication
(10) Pub. No.: US 2009/0258336 A1
(43) Pub. Date: Oct. 15, 2009

(54) SYSTEM AND METHOD FOR DEVELOPMENT OF INTERPERSONAL COMMUNICATION

(75) Inventor: Molly J. Foote, Bellingham, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: CULTIVATING CONNECTIONS, INC., Bellingham, WA (US)

(21) Appl. No.: 12/423,651

(22) Filed: Apr. 14, 2009

Related U.S. Application Data
(60) Provisional application No. 61/124,235, filed on Apr. 14, 2008.

(51) Int. Cl. G09B 7/00

(52) U.S. Cl. 434/362

(57) ABSTRACT

A method for facilitating communication between participants is provided. The method includes providing a plurality of individually-identifiable tokens to at least first and second participants, associating a unique question with each token, transferring a first token from the first participant to the second participant, asking the second participant the question that is associated with the first token, transferring a second token from the second participant to the first participant, and asking the first participant the question that is associated with the second token. The method further includes recording the answers that are provided by the first and second participants in response to the questions associated with the first and second tokens.

### CROSS-REFERENCE TO RELATED APPLICATION

This application claims the benefit of U.S. Provisional Application No. 61/124,235, filed on Apr. 14, 2008, the disclosure of which is hereby expressly incorporated by reference.

### FIELD OF THE TECHNOLOGY

The present disclosure relates generally to a system and method for aiding development of communications and understanding between persons, and more particularly, to a method and apparatus that aids development of such communications and understanding by employing exchangeable tokens or articles that are associated with pre-assigned questions that are to be asked or topics that are to be discussed between individuals when they are exchanged.

### BACKGROUND

The benefits of interpersonal communication and understanding are immeasurable, but initiating communication on a one-to-one basis is a formidable obstacle for many or most people. True, most people communicate, more-or-less effectively with family members, friends and coworkers, but the willingness to do so is the result of long-term acquaintance, typically acquired over a period of years. Moreover, family, friends and coworkers represent only a small, limited group, with a result that if, one communicates only with members of these groups, the scope of one's understanding and knowledge will remain similarly constrained.

Nevertheless, initiating communication beyond one's familiar group can be uncomfortable and is therefore avoided by many people. This phenomenon may be the result of social conditioning or other factors, but it nevertheless remains largely true, even across cultures.

Recognizing these difficulties, numerous “conversation starters”, “ice breakers”, and similar aids to personal communication have been employed over the years.

Examples run the gambit from simple greeting and introduction sessions to various games and group activities. Effective as they may be, such techniques are typically involved only within a finite, predetermined group of individuals, such as people at a party, conference attendees, a group of students, and so on. They are also generally dependent on the presence of a moderator or other person who will lead the activity (e.g., a host, a teacher, and so on), which is simply not an element of most ordinary day today personal interactions. In short, most of such prior techniques are by their nature limited to facilitating communication to a relatively small group of individuals, again generally drawn together by some shared interest or common background.

Paradoxically, while the Internet, for all that it has accomplished in terms of electronic communications, seems to have done little to foster person-to-person communication on a real world basis. Simply put, the ease of being able to communicate on a semi-anonymous basis, without meeting and often in the context of an online “persona” bearing only limited similarity to one's real personality, appears to have had the effect of making it harder for some of these same individuals to reach out and communicate with people on a real world, face-to-face basis. Moreover, in some respects the tendency to communicate without making face-to-face contact can be negative in its consequences, since (similar to drivers contained within the shells of their automobiles) people who know one another only from their online personas may have a distorted understanding of each other or groups to which they belong and may be willing to make negative assumptions or remarks that would not be the case if they had actually met in person.

Accordingly, there exists a need for a system and method for fostering interpersonal communication outside of confined, pre-established groups based on existing personal relationships and the like. Furthermore, there exists a need for such a system and method that does not require the physical presence of a moderator or other third person in order to be effective. Still further, there exists a need for such a system and method that, in addition to the benefits of communication, provides an enjoyable experience for the participants, so as to sustain growth and increase the scope of participation therein. Still further, there exists a need for such a system and method that is able to meld face-to-face communications with the capabilities of electronic communication via of the Internet or another suitable network, so as to be able to effectively promote communications across both geographic and cultural/political boundaries.

### SUMMARY

A method for facilitating communication between participants is provided. The method includes providing a plurality of individually-identifiable tokens to at least first and second participants, associating a unique question with each token, transferring a first token from the first participant to the second participant, asking the second participant the question that is associated with the first token, transferring a second token from the second participant to the first participant, and asking the first participant the question that is associated with the second token. The method further includes recording the answers that are provided by the first and second participants in response to the questions associated with the first and second tokens.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

FIG. 1 is a graphical depiction of two participants engaged in communication facilitating a preferred method of a system and method formed in accordance with one embodiment of the present disclosure;

FIG. 2 is an isometric view of the hands of the two participants shown carrying out one aspect of the system and method of the present disclosure;

FIG. 3 is an isometric view of a wristband worn by the persons in FIGS. 1 and 2 for carrying out aspects of the system and method of the present disclosure;

FIGS. 4A and 4B are, respectively, front and rear isometric views of a representative token detachably securable to the wristband shown in FIG. 3;

FIG. 5 is an isometric view of a group of cards associated with the tokens shown in FIGS. 4A and 4B;

FIG. 6 is an isometric view of the hands of the two participants of FIG. 1, shown carrying out one aspect of the system and method of the present disclosure;

FIG. 7 is an isometric view of a participant carrying out one aspect of the system and method of the present disclosure with a computer;

FIG. 8 is an exemplary pictorial depiction of a networking environment for carrying out aspects of the present disclosure, wherein the networking environment includes a supplier server and a plurality of client computers;

FIG. 9 is a an exemplary pictorial depiction of a computer architecture for the supplier server depicted in FIG. 8;

FIGS. 10A-10C is an exemplary flow diagram of a method for carrying out aspects of the system and method of the present disclosure;

FIG. 11 is an exemplary pictorial depiction of a first web page suitable for carrying out aspects of the system and method shown in the flow diagram of FIGS. 10A-10C;

FIG. 12 is an exemplary pictorial depiction of a second web page suitable for carrying out aspects of the system and method shown in the flow diagram of FIGS. 10A-10C;

FIG. 13 is an exemplary pictorial depiction of a third web page suitable for carrying out aspects of the system and method shown in the flow diagram of FIGS. 10A-10C;

FIG. 14 is an exemplary pictorial depiction of a fourth web page suitable for carrying out aspects of the system and method shown in the flow diagram of FIGS. 10A-10C;

FIG. 15 is an exemplary pictorial depiction of a fifth web page suitable for carrying out aspects of the system and method shown in the flow diagram of FIGS. 10A-10C;

FIG. 16 is an exemplary pictorial depiction of a sixth web page suitable for carrying out aspects of the system and method shown in the flow diagram of FIGS. 10A-10C;

FIG. 17 is an exemplary pictorial depiction of a seventh web page suitable for carrying out aspects of the system and method shown in the flow diagram of FIGS. 10A-10C;

FIG. 18 is an exemplary pictorial depiction of a eighth web page suitable for carrying out aspects of the system and method shown in the flow diagram of FIGS. 10A-10C;

FIG. 19 is an exemplary pictorial depiction of a ninth web page suitable for carrying out aspects of the system and method shown in the flow diagram of FIGS. 10A-10C;

FIG. 20 is an exemplary pictorial depiction of a tenth web page suitable for carrying out aspects of the system and method shown in the flow diagram of FIGS. 10A-10C;

FIG. 21 is an exemplary pictorial depiction of a eleventh web page suitable for carrying out aspects of the system and method shown in the flow diagram of FIGS. 10A-10C;

FIG. 22 is an exemplary pictorial depiction of a twelfth web page suitable for carrying out aspects of the system and method shown in the flow diagram of FIGS. 10A-10C;

FIG. 23 is an exemplary pictorial depiction of a thirteenth web page suitable for carrying out aspects of the system and method shown in the flow diagram of FIGS. 10A-10C;

FIG. 24 is an exemplary pictorial depiction of a fourteenth web page suitable for carrying out aspects of the system and method shown in the flow diagram of FIGS. 10A-10C;

FIG. 25 is an exemplary pictorial depiction of a fifteenth web page suitable for carrying out aspects of the system and method shown in the flow diagram of FIGS. 10A-10C; and

FIG. 26 is an exemplary pictorial depiction of a sixteenth web page suitable for carrying out aspects of the system and method shown in the flow diagram of FIGS. 10A-10C.

### DETAILED DESCRIPTION

The present disclosure is generally directed to a system and method for facilitating interpersonal communication between people who meet face-to-face and for facilitating expansion of the communication with other people and other geographic locals utilizing the capabilities of the Internet or another data network. It should be appreciated that the steps for performing the method, as well as the system components and the means for implementing the method, may be modified without departing from the spirit and scope of the present disclosure.

A first portion of the system and method for facilitating interpersonal communication includes the exchange of a physical or virtual article (referred to herein as a “token”) between participants, each token being individually identifiable and having a question, topic of discussion, quote, etc. (hereinafter sometimes collectively referred to as “questions”), that is associated with the token at the time of exchange. Participants are identifiable by either wearing or displaying the tokens in a visible manner or otherwise identifying themselves as having virtual tokens in any suitable manner. The visually identifiable tokens enable participants to identify and make contact with one other. Moreover, the uniqueness and interchangeability of the tokens provides a means for tracking and exploring further contacts as the tokens are exchanged between subsequent participants. The questions, topics of discussion, quotes, etc., associated with the tokens provide a mechanism for the individuals to exchange a small item of personal interest and further serve as a starting point for a longer, more substantive conversation.

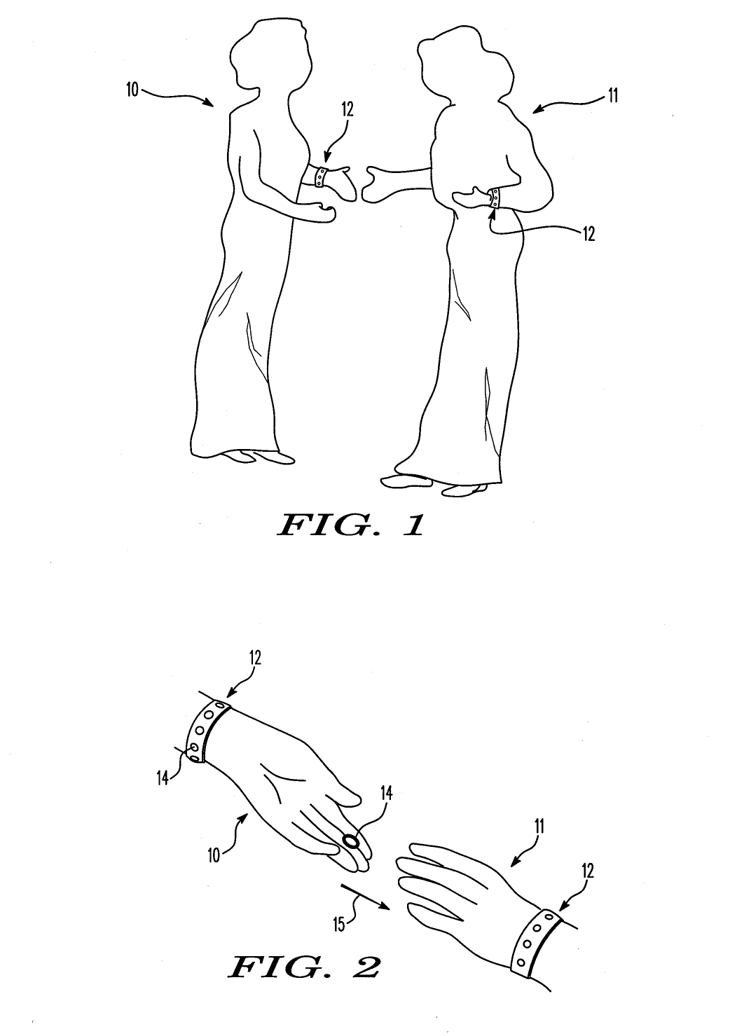

Referring to FIGS. 1-7, a representative embodiment of the first portion of the system and method for facilitating interpersonal communication will be hereinafter described in detail. The first portion of the system and method includes the use of several system components to encourage communication between participants who meet face-to-face. FIG. 1 depicts first and second participants 10 and 11 engaged in conversation. Each participant wears a bracelet or wristband 12 on which tokens 14 are displayed, as shown in FIG. 2. The tokens 14 are detachably secured to the wristbands 12 such that each token 14 can be exchanged between participants 10 and 11, as indicated by arrow 15.

The visibility of the tokens 14 on the wristbands 12 enables participants to identify one another and feel confident that the other participant will welcome communication, thereby encouraging face to face communication. In this regard, it will be recognized that a wristband is only one example of a way in which the tokens 14 can be displayed, and that any other suitable accessory or wearable article can be used for this purpose. Moreover, if the participants are using virtual tokens, as will be described in more detail below, the participants may instead wear any identifying accessory, article, etc., to inform other participants that he or she is a participant with virtual tokens.

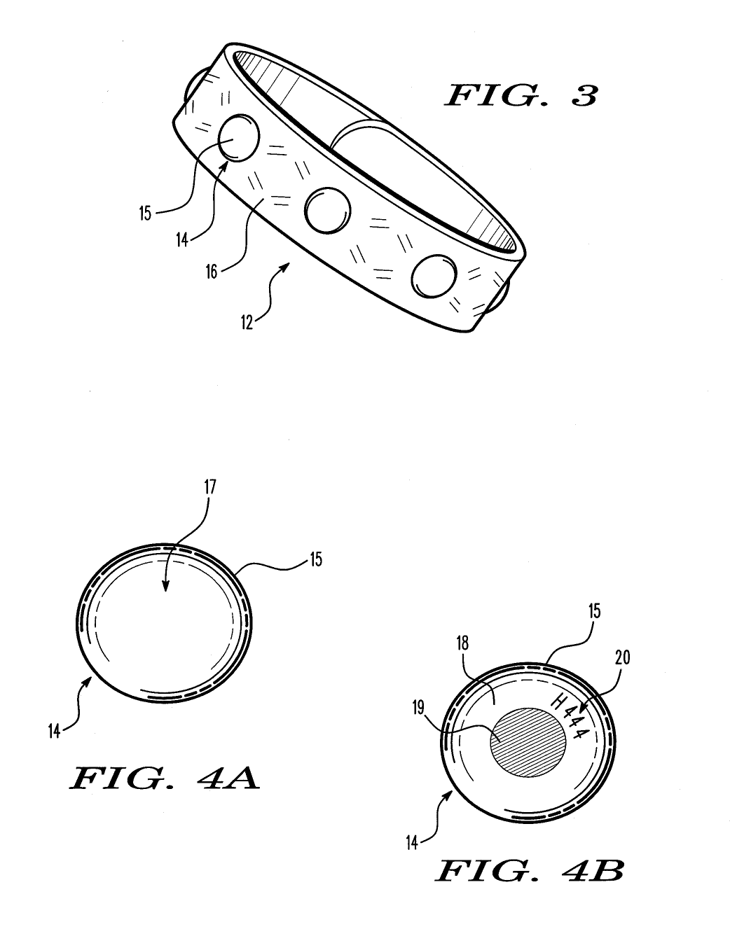

Referring to FIGS. 3, 4A, and 4B, in the illustrated embodiment, the tokens 14 are simple decorative snaps 15 detachably secured to a web 16 of the wristband 12 using a conventional stud and socket assembly (shown partially in FIG. 4B) or any other suitable attachment assembly well known in the art or later developed. It should be appreciated that any other type of token 14 may be used, such as, for example, a piece of fabric or other material detachably secured to the web 16 by Velcro®. Thus, it should be appreciated that the description of the token as a snap 15 should not be seen as limiting the scope of the claimed subject matter.

The snaps 15 (or other attachable tokens) are preferably aesthetically pleasing and sufficiently distinctive as to be identifiable by other participants, but otherwise the shape, color and so forth are substantially arbitrary. In the illustrated embodiment, each of the detachable snaps 15 includes an outer surface 17 and an opposite inner surface 18. The outer surface 17 is preferably defined by a decorative, distinctive, brightly-colored pearlized or glass material, giving the wristband 12 a pleasant appearance and resembling, for example, a piece of costume jewelry. The inner surface 18 defines a socket 19 for receiving the operating attachment stud such that the snap 15 may be individually and detachably secured to the web 16 of the wristband 12 as desired. An identification number 20 or other identifying indicia particular to the individual token or snap 15 may be provided on the inner surface 18; however, it should be appreciated that the number 20 may instead be located elsewhere on the snap 15. Each snap 15, or token 14 includes an individual identifier that is associated with a topic, question, etc., for initiating conversation between participants when the tokens are exchanged. It should be appreciated that in some instances, the question or topic itself may be displayed on the token in addition to or in lieu of the identification number.

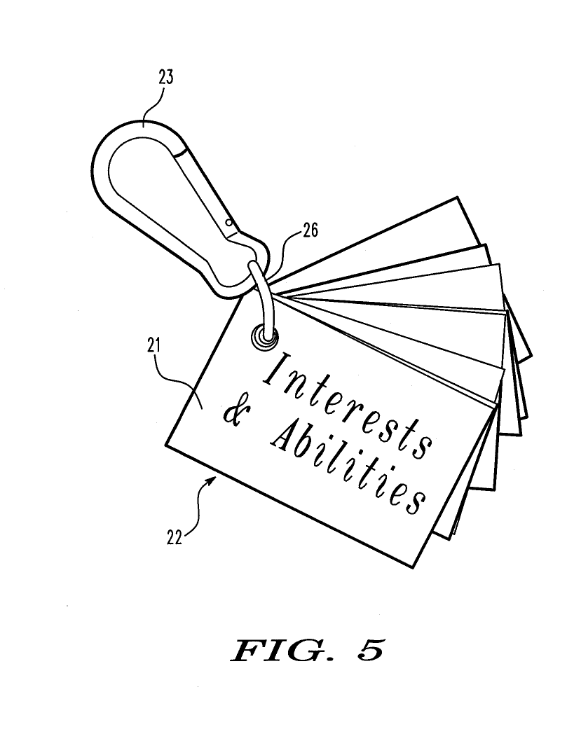

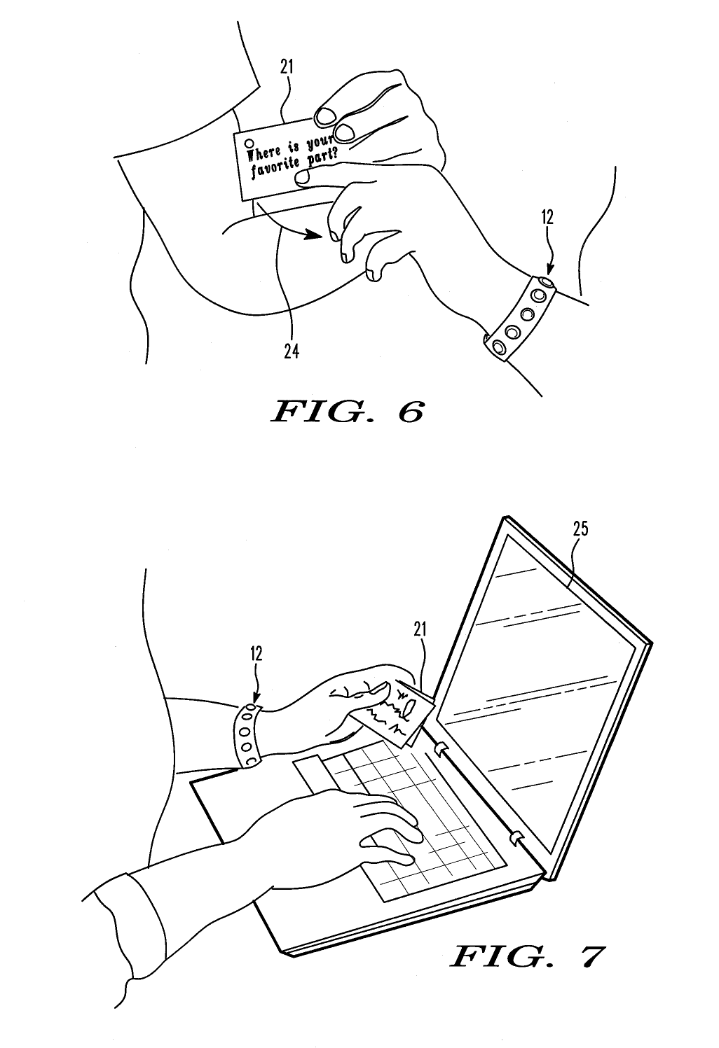

Thus, at the time of meeting, one participant asks the other for a token 14, which when removed reveals the identification number 20. The gifting participant then asks the requesting participant the question associated with that particular token, e.g., “What is your favorite flavor of ice cream?” In so doing, the gifting participant may refer to a listing of the identification numbers and associated questions printed on cards 21, as shown in FIGS. 5 and 6. As can be seen in FIG. 5, the participant can carry a set 22 of cards 21 joined together by a ring 26 or other connector from which they can be detached. The ring 26 may be coupled to a carabiner 23 that is detachably securable to a belt loop, purse, bag strap, etc., for easy access.

As can be seen in FIG. 6, the first participant gives the question card 21 to the other participant, as indicated by arrow 24, preferably after first asking the question and passing the token to the receiving participant as shown in FIG. 2. Although the cards 21 may be used for referencing the question, topic, etc., associated with the number 20 on the token 14, it should be appreciated that other methods for referencing the question, topic, etc. may be used, and in some instances the participant may have committed the numbers and questions to memory.

After responding to the question, the receiving participant then asks the same question of the giving participant, and notes or records the first person's answer. The second participant then requests a token 14 from the other participant, and the process is repeated with the question associated with the second token. The exchanged tokens 14, or in this embodiment, the snaps 15 are then attached to the recipients' respective wristband 12 in the vacant location and carried until exchanged with another participant at a later time. Similarly, the traded question cards 21 are attached to their new owner's ring 26 or other carrier. Then, at such time as possible, each participant enters the relevant information from the exchange into an Internet-accessible database, as will be described in greater detail below, for example using a laptop computer 25 as shown in FIG. 7.

Of course, the point of the exchange between the participants is not merely to ask and answer a couple of questions per se. Rather, the questions are preferably structured such that the answer itself is a simple piece or bit of defined information (e.g., one or a few words) that can be remembered and/or entered into a database, but which also reflects some personal interest, feeling, capability or the like, so as to provide a degree of insight or understanding with regard to the participant who supplied it. Consequently, the questions are perfectly tailored that they can be answered easily and comfortably by any person who wishes to participate. Moreover, the questions are preferably structured so that they serve as an introduction or “lead in” to a more substantive, rewarding discussion between the two participants. As a non-limiting example, an exchange between two participants might go as follows:
Participant One: “What's your favorite flavor of ice cream?”
Participant Two: “Vanilla.”
Participant Two: “What's your favorite flavor of ice cream?”
Participant One: “Chocolate.”
Both: “Hmmm”
Participant Two: “If you were a car, what make would you be?”
Participant One: “A Bentley”
Participant Two: “Wouldn't we all!”
Participant One: “If you were a car, what make would you be?
Participant Two: “A Volkswagen™ Bus”
Participant One: “A what? How interesting-why that?”
Participant Two: “Well, my parents had one when we were kids, and it was really fun and practical.”

The exemplary questions used above and elsewhere herein are somewhat simplistic for ease of understanding the invention. It will be understood, however, that the questions may be more involved or sophisticated if desired. Moreover, in some embodiments the questions may be tailored to participants belonging to a target group or demographic. For example, questions might be tailored to school-age children, to persons who are attending a business or technical conference, and so on.

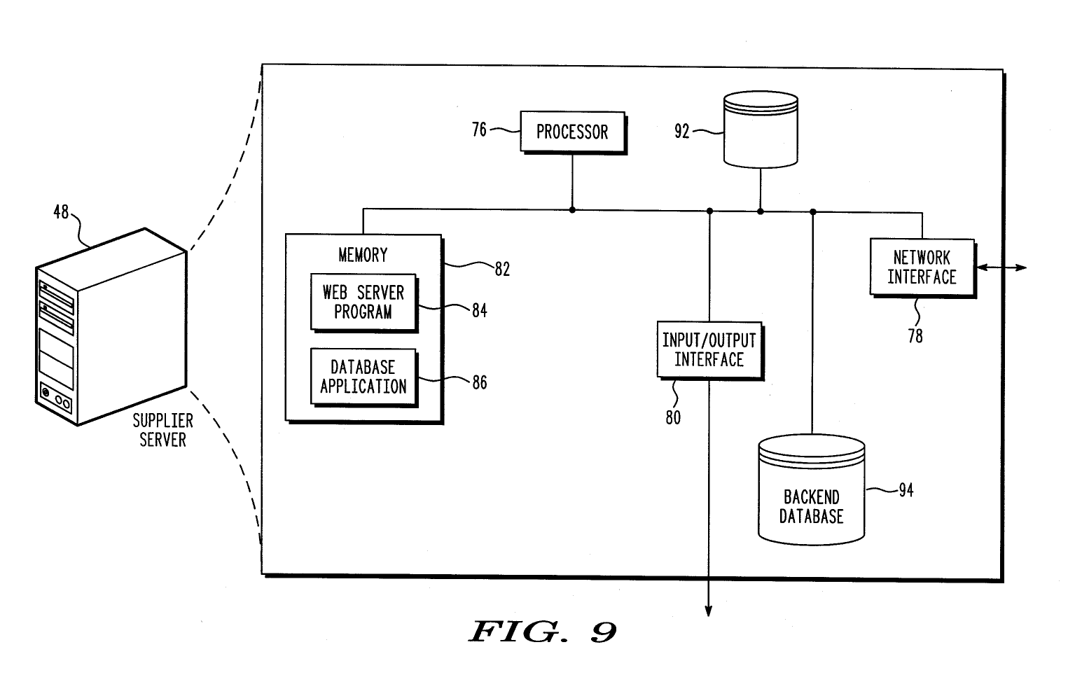

The tokens 14, wristbands 12, and cards 21 (“system components”) may be made by a supplier that also facilitates implementation of and maintenance of the expansion of the communication with other people and other geographic locals utilizing the capabilities of the Internet or another data network (i.e. creation of and maintenance of a database, website, etc.). In the alternative, the system components may instead be made supplied by a third party supplier. For the sake of clarity, the supplier of the system components and the party implementing and maintaining the database, website, etc., will be hereinafter referred to as “supplier” for simplicity. The supplier may generate the question, topic, etc., for each token 14 and assign a corresponding unique identification number 20 or other indicia to the token 14 through any suitable means, such as with a database application like Microsoft Access®. The questions, topics, etc., and the unique identification number 20 are stored in a suitable database (see database 92 in FIG. 9) accessible by the participants via a website or other application managed by the supplier.

It should be appreciated that various alternative physical and virtual token embodiments may instead be employed. For instance, the above-described tokens 14 may instead be customizable such that each participant may design or choose the topic, question, etc., for each token. In addition, organizations may customize a set of tokens that include questions or topics directed to certain activities within the organization or that fulfill a purpose in developing relationships between individuals within the organization. For example, customized tokens could be created for students for use at a freshman orientation at a university. The questions may, for instance, relate to the university and/or topics that the university wants the students to learn and discuss.

Custom tokens could also be used for an icebreaker activity at a conference. Unique questions could be created to assist the conference attendees in connecting with one another and engaging in the conference. As yet another example, customized tokens could be created for a school to help facilitation of discussion about certain topics, such as a topic discussed by a school assembly speaker. The speaker could design the token questions and topics to relate to his or her message and give the tokens to the students after the assembly. In this manner, the students and staff could continue to share the message of the speaker after the assembly, thereby increasing the likelihood that the message will be retained.

As yet another alternative, the tokens may instead be a device containing a Bluetooth or Radio-Frequency Identification (RFID) microchip that are programmable to include customizable or otherwise unique token information. For instance, the token could be customized to contain marketing information specific to the token owner or to the organization associated with the tokens. In this manner, the token could act like a business card. The token could instead be pre-programmed to include a unique question, topic, etc., for use by everyday participants, as described above. The programmable token may be readable through wireless technology or any other suitable technology by any suitable reader device, such as a personal digital assistant (PDA), a cell phone, a handheld video game console, or any other type of handheld computer device in a manner well known in the art. As such, the question, topic, etc., associated with the token may be retrieved through the person's handheld computer device without the need to memorize the question or topic associated with the token and without the need to carry separately the cards 21 containing the corresponding questions and topics.

The programmable token may also be readable by any other suitable device, such as a video game console, a television, a laptop, etc. For instance, a player's tokens may be read by a video game console (Wii®, Nintendo®, XBox®, Sega®, etc.), and the video games for use with the console could be programmed to access the token information and provide the player with the information stored in the token. Thus, if the tokens were readable by the video game console, the video game could provide the player with motivational comments while he or she is playing, such as “you can do it, etc.”

As yet another alternative, and as mentioned above, the tokens may instead be “virtual tokens” that are exchangeable and accessible by electronic means. For instance, the virtual tokens may be packets of information stored and accessible through an application on a participant's PDA, cell phone, or other handheld computing device. The virtual tokens may instead be stored within a database accessible by the handheld computing device. The virtual tokens can be sent to another participant via a text message, an email, etc., by any wireless technology well known in the art. The virtual token may instead be stored on an electronic key fob device that is readable by the handheld computer device or any other suitable electronic device. If the participants are using virtual tokens, the participants may still wear a wristband 12 or may instead wear any identifying accessory, article, etc., to inform other participants that he or she is a participant with virtual tokens.

Based on the foregoing, it should be appreciated that the tokens may be any suitable physical or virtual articles that are unique to a topic, question, etc., and that are exchangeable between participants. Regardless of the embodiment used, the exchangeable tokens constitute identifiable, exchangeable articles that facilitate real-world communication between individuals on a face-to-face basis. The questions associated with the tokens not only act as conversation starters, they also elicit defined items or “nuggets” of personal interest relating to each of the participants. Furthermore, because the token corresponds to a unique question, topic, etc. (identifiable by indicia or otherwise), the “nugget” of information can be associated with the particular token at the time of exchange. Hence, the items of personal interest can be recorded each time a token 14 is exchanged, creating a chain or trail of items of information as possession of the token progresses from participant to participant.

The participants can record the “nugget” of information corresponding to the exchanged token in any suitable manner, preferably by entering the relevant information in a database that is accessible via the Internet, i.e., preferably via an online website accessible through a handheld device or a computer 25, as shown in FIG. 7. Recording the information facilitates expansion of the communication with other people and other geographic locals utilizing the capabilities of the Internet. The originator of the token (i.e., the first person to have possessed the token) and all subsequent participants who have possessed the token will be able to employ the internet to track the progress of their tokens and view the “nuggets” of information along the way, across regional and cultural boundaries.

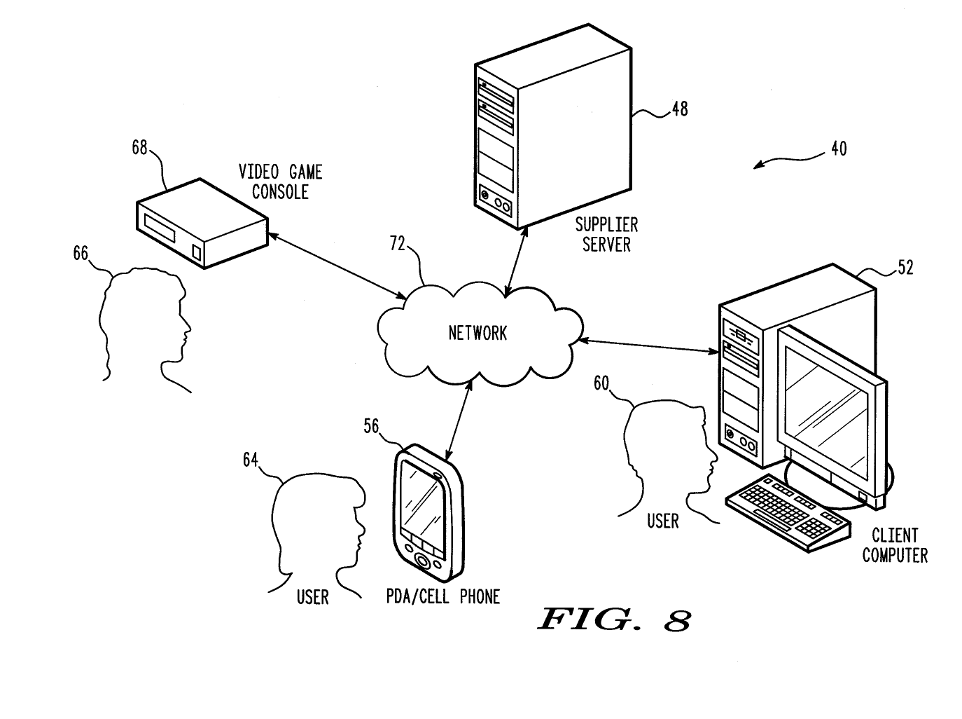

Referring to FIG. 8, a brief, general description of a networking environment 40 suitable to implement the second portion of the system and method for facilitating interpersonal communication will be hereinafter described. It should be appreciated that the networking environment 40 hereinafter described is provided for illustrative purposes only. Moreover, although specific system configurations are illustrated, it should be understood that examples provided herein are not exhaustive and do not limit the present disclosure to the precise forms disclosed. Persons having ordinary skill in the field of computers will recognize that components described herein may be interchangeable with other components or combinations of components and still achieve the benefits and advantages of the disclosed system and method. The computer components hereinafter described may be grouped in a single location or distributed over a wide area.

The networking environment 40 is comprised of a plurality of computers, namely, the supplier server 48, the client computer 52, the PDA 56, and the video game console 68. Moreover, the client computer 52, the PDA 56, and the video game console 68 are shown associated with users 60, 64, and 66, respectively. It should be appreciated that the PDA 56 is representative of any type of handheld computing device, including a cell phone, a handheld video game console, etc. In any event, the supplier server 48 is configured to communicate with the client computer 52, the PDA 56, and the video game console 68 via a network 72, which may be implemented as a local area network (“LAN”), a wide area network (“WAN”), or the global network commonly known as the Internet. As known to those skilled in the art and others, the computers 48, 52, 56, and 68 illustrated in FIG. 8 may be configured to exchange files, commands, and other types of data over the network 72. However, since protocols for network communication such as TCP/IP are well known to those skilled in the art of computer networks, those protocols will not be described herein.

The functions performed by the computers described with reference to FIG. 8 may instead be implemented by a plurality of computers. For example, while the supplier server 48 is illustrated as a single computer, server-based functionality is frequently handled in a “server farm” in which multiple servers cooperate in executing necessary tasks so that requests from potentially large numbers of users may be satisfied. Moreover, in addition to the conventional computer systems illustrated in FIG. 8, those skilled will recognize that the present method may be practiced on other kinds of computers, including laptop computers, tablet computers, or any other suitable device on which computer software or other digital content may be executed.

Now referring to FIG. 9, an exemplary architecture of the supplier server 48 depicted in FIG. 8 that illustrates computer components suitable to implement aspects of the present system and method will be described. Those skilled in the art and others will recognize that the supplier server 48 illustrated in FIG. 9 may be any one of a variety of devices including, but not limited to, personal computing devices, server-based computing devices, mini and mainframe computers, laptops, or other electronic devices having some type of memory. In the embodiment illustrated in FIG. 9, the supplier server 48 includes a processor 76 in communication with a variety of computing elements, including a network interface 78, an input/output interface 80, and a memory 82.

The network interface 78 depicted in FIG. 9 enables the supplier server 48 to communicate data, control signals, requests, and other information via a communication network (LAN, WAN, Internet, etc.) such as the network 72 described above with respect to FIG. 8. For instance, the supplier server 48 may receive requests from other networked computers and transmit data back to a requesting computer using the network interface 78.

The input/output interface 80 enables the supplier server 48 to communicate with various local input and output devices. An input device in communication with the input/output interface 80 may include computing elements that provide input signals to the supplier server 48, such as a keyboard, mouse, external memory, disk drive, etc. Also, an output device in communication with the input/output interface 80 may include computing elements that accept output signals such as a monitor, a printer, and the like.

The processor 76 is configured to operate in accordance with computer program instructions stored in a memory, such as the memory 82. In some computing systems, program instructions may also be embodied in a hardware format, such as a programmed digital signal processor. In any event, as illustrated in FIG. 9, the memory 82 stores a web server program 84 and a database application 86.

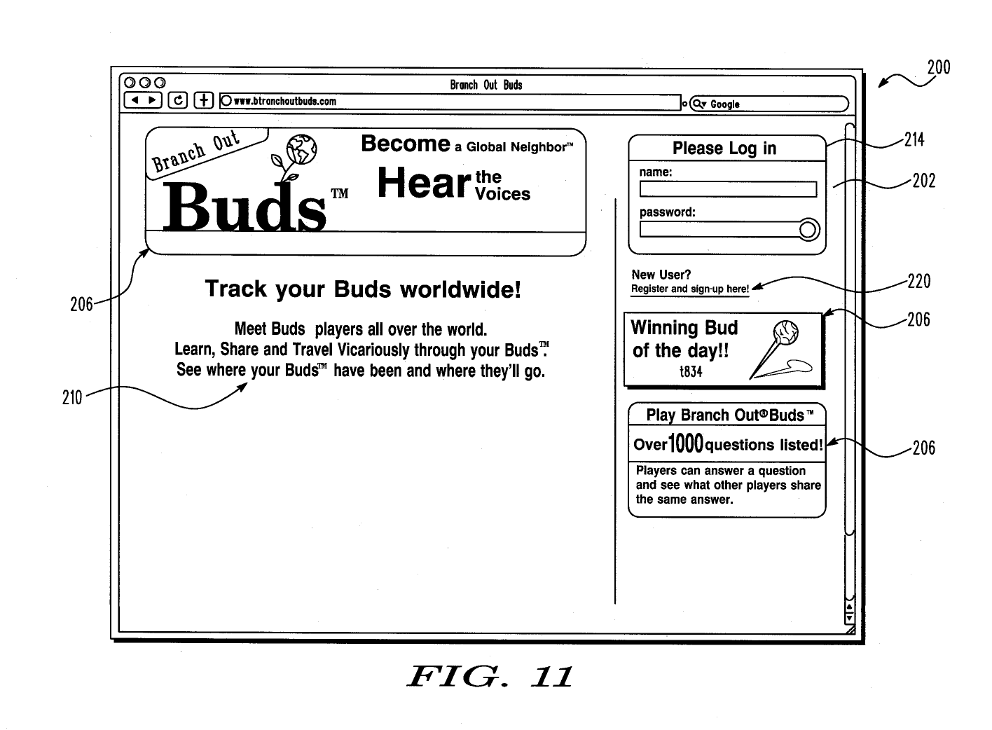

The web server program 84 illustrated in FIG. 9 comprises computer-executable instructions that, when executed by the processor 76, generates configurable markup documents (hereinafter referred to as “web pages”), such as the sample web pages depicted in FIGS. 11-28, that are described in more detail below. The web server program 84 provides a way for the supplier server 48 to interact with users of other network-accessible computers. For example, the web server program 84 is configured to generate web pages and cause markup code from web pages to be accessible from the network 72. When a web page is accessed, the web server program 84 may receive data back from a network computer that describes the user's interactions with the web page. In accordance with one embodiment of the presently disclosed method, the content of the web pages generated by the web server program 84 serve as an interface that enables users to record answers from other participants, track the progress and movement of tokens, interact with other participants, etc.

The web server program 84 also interacts with other computer components illustrated in FIG. 9 so that the appropriate data may be obtained from or communicated to a user. For example, a request to retrieve a question, topic, etc., corresponding to a token identification number 20 may be obtained from a user. In this instance, data associated with the request is received at the web server 84 and forwarded to the database application 86 so that the database 92 may be updated. As noted above, the database 92 is responsible for storing data that includes, but is not limited to, the topic, question, etc. associated with each identification number 20 or other identifying information for each token 14. The database 92 further stores input data received by participants interacting with the web pages, such as information pertaining to the participant's profile, the answers or remarks to the questions or topics, etc. In this regard, the database application 86 provides mechanisms for updating and/or retrieving data stored in the database 92 such that a user may track information and interact with other participants through the web site. The web server program 84 may also interact with the database application 86 to retrieve data from a backend database 94 that stores the data necessary to provide the web pages for enabling users to interact with the web site. It should be appreciated that the database 92 and backend database 94 may instead be combined into one database, or instead, additional databases may be used.

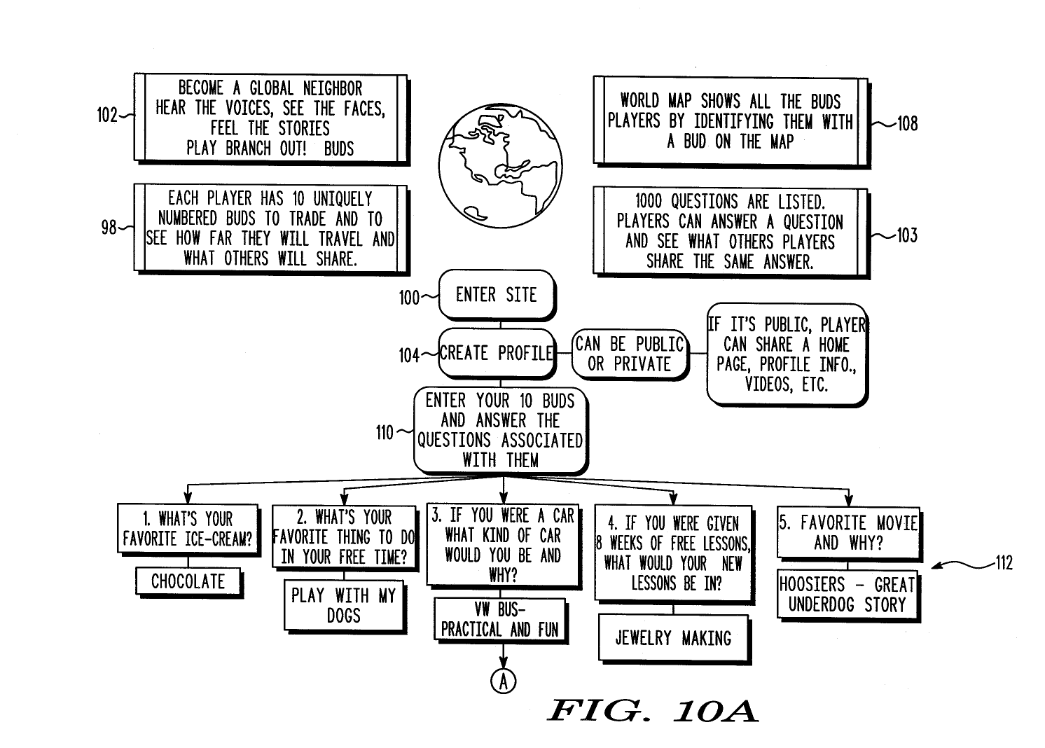

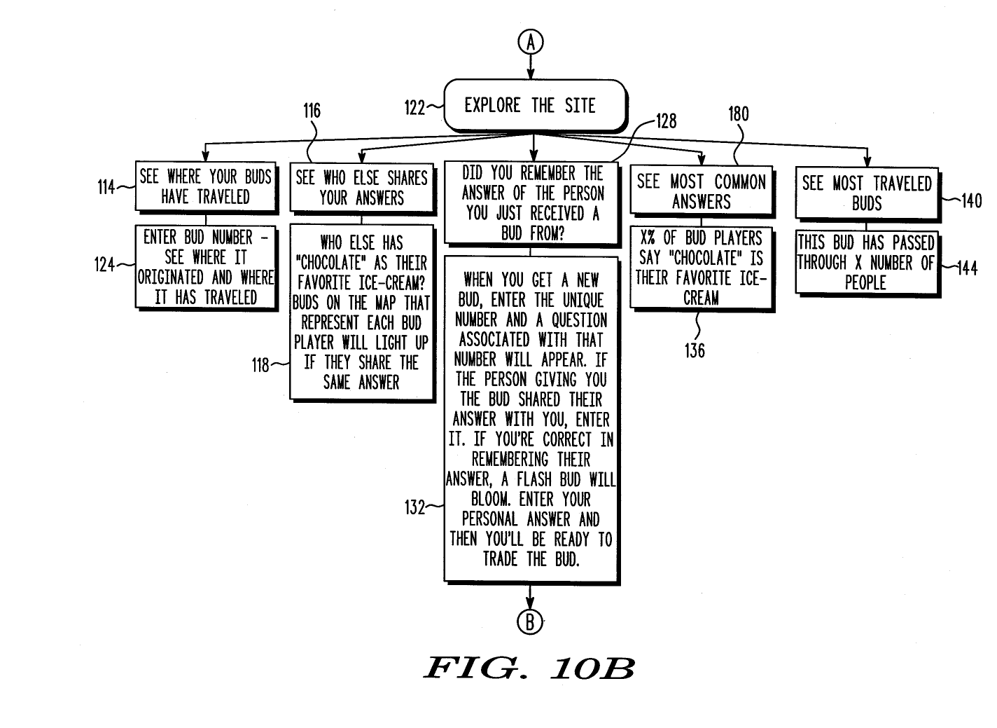

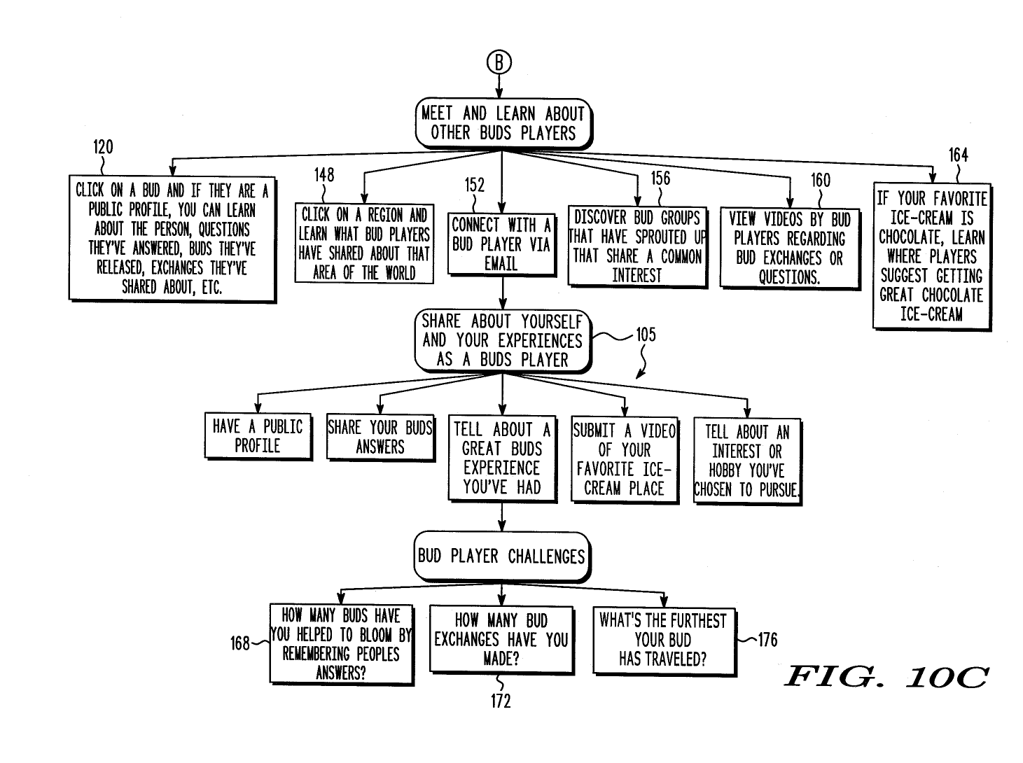

Referring to FIGS. 10A-10C, a flowchart depicting an exemplary website facilitating the expansion of communication with other participants and other geographic locals utilizing the capabilities of the Internet is provided. Moreover, FIGS. 11-28 are exemplary web pages of a website implementing the process depicted in FIGS. 10A-10C. Throughout FIGS. 10-28, the tokens are referred to by the term “Buds”. It will be understood that the questions, terminology, layout and so on of FIGS. 10-28 are provided by way of example rather than limitation, and that embodiments may vary widely in these aspects depending on design considerations, target audiences and other factors.

As can be seen in block 98 of FIG. 10A, each participant begins with a collection of tokens, suitably purchased or otherwise obtained by exchanging tokens with other participants, each of which bears an individual identification number or other identifying indicia. After acquiring the tokens, the participant accesses a website suitable to carry out aspects of the disclosed method. Upon accessing the website, the exemplary web page 200 shown in FIG. 11 is displayed. The exemplary web page 200 depicted in FIG. 11 includes a display area 202 for presenting graphical information 206 and textual information 210 that enables a user understand the purpose of the website, as indicated by blocks 102, and 103 of FIG. 10A. Further included in the display area 202 is a text box 214 for entering a user name and password to enter the website and access the contents of the website, as indicated by block 100. A new user can instead register to use the website by activating a link 220.

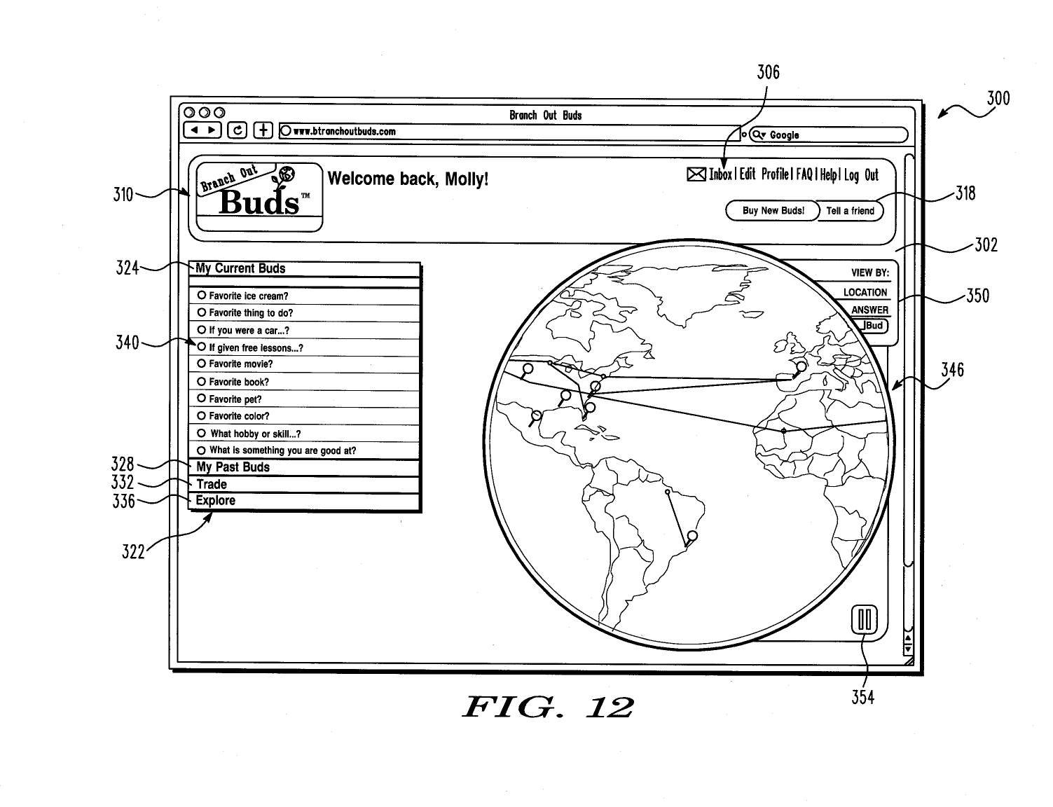

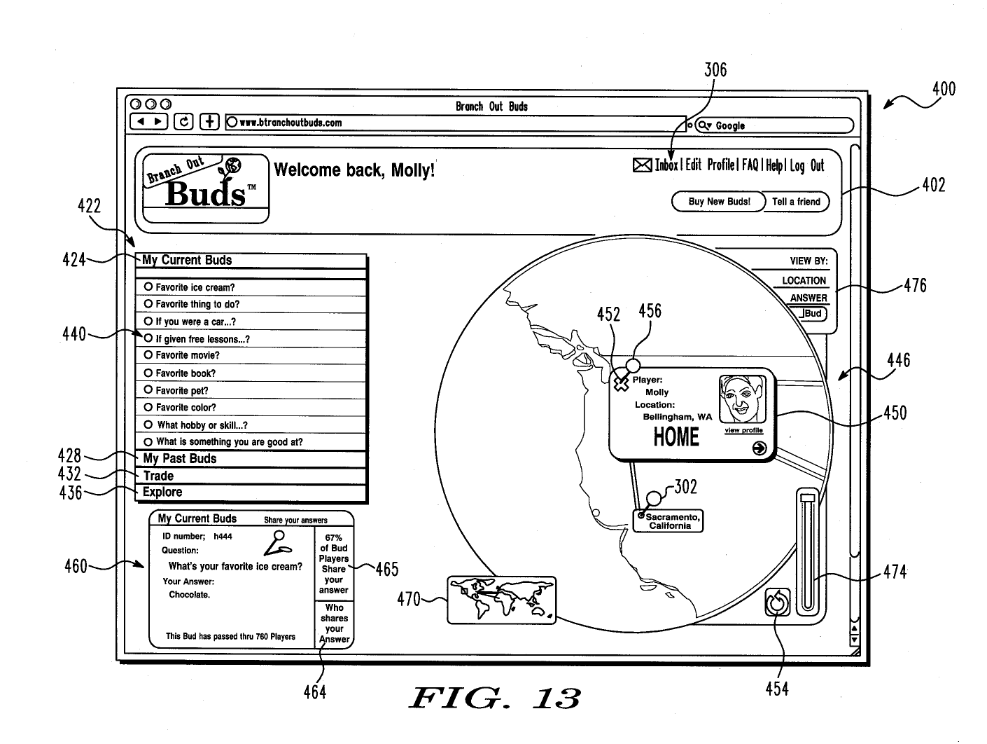

Upon entering the website, the participant accesses the home web page, which is depicted as exemplary web page 300 in FIG. 12. The web page 300 includes a display area 302 having certain graphical images 310 as well as active links that are preferably shown and available on all or substantially all the web pages upon entering the web site. For instance, the web pages may include a link 306 for accessing, editing, or creating a public profile, as indicated by blocks 104 and 105, that is accessible by other participants via the website. The profile may contain personal information, such as geographic location, a profile picture, links, shared experiences, suggestions or comments pertaining to the questions or topics associated with the Buds, and so on. For example, the profile may include links to a chat room, a Face Book^{SM} page, a YouTube^{SM} video, and so on.

The public profile information of the participant will be available to others in certain circumstances, such as when participants exchange Buds. The originator as well as any intermediate participants will be able to see the Bud player's profile information when the Bud is currently in the participant's possession. Moreover, the profile information of the originator and any intermediate Bud holder will be available to the current Bud holder. In this manner, the website can enable participants to meet and learn more about other participants across geographical and cultural boundaries as the Bud travels from participant to participant.

The web pages may further include a link 314 to “Buy new Buds,” i.e. purchase new tokens through the website with an online ordering process or any other suitable process well known in the art. The web pages may further include a link 318 to “Tell a friend” about the website, possibly by providing a means to email a friend or otherwise contact a person through the website. The web pages may further include links to access an Inbox for retrieving electronic mail through the web site, a link to access frequently asked questions (FAQ), a link for “help” with the website, or a link to log out of the website. Such links are common on web pages available over the Internet; and therefore, they will not be described in greater detail.

Web page 300 further includes a menu 322 having menu items that allow the user to explore the website, as indicated by block 122 in FIG. 10B, which may include tracking Bud information, learning about and interacting with other participants, accessing additional information compiled from the ongoing exchanges and movements of the Buds that are in or have passed through their possession, etc.

For example, a first menu item “My Current Buds” 324 can be activated to drop down a list of Bud buttons 440 that represent Buds currently in the participant's possession. The participant may click on one of the Bud buttons 440 to view information pertaining to the Bud in a “My Current Buds” graphical image 460, as shown in the web page 400 depicted in FIG. 13. The information may include the identification number of the Bud, the question or topic associated with that Bud, and the participant's response. Moreover, as indicated by block 116 in FIG. 10B, the participant may further click on an active link “Who Shares your Answer” 464 within the graphical image 460 to see what percentage of Bud players share the participant's answer, which will also appear as a textual image 465 within the graphical image 460.

The web page 400 further includes a rotatable globe image 446, as indicated by block 108 in FIG. 10A, depicting the location of past and present Buds, information relating to the holder of the Bud, indications of where the Bud has traveled, and any other relevant information pertaining to the Bud that can be displayed. Referring to the rotating globe image 746 depicted on web page 700 of FIG. 16 for ease of description, the current locations of each of the tokens or Buds is indicated by a visual representation of a map pin 756, while the locations of intermediate (now former) holders are indicated by small circles 758. These locations, and that of the originator as indicated by an “X” symbol 752, are interconnected by map lines 762 to provide a visual representation of the “travels” of each Bud and it has been traded from one participant to the next. The map lines 762 may be color coordinated with the map pin images 756 for clarity.

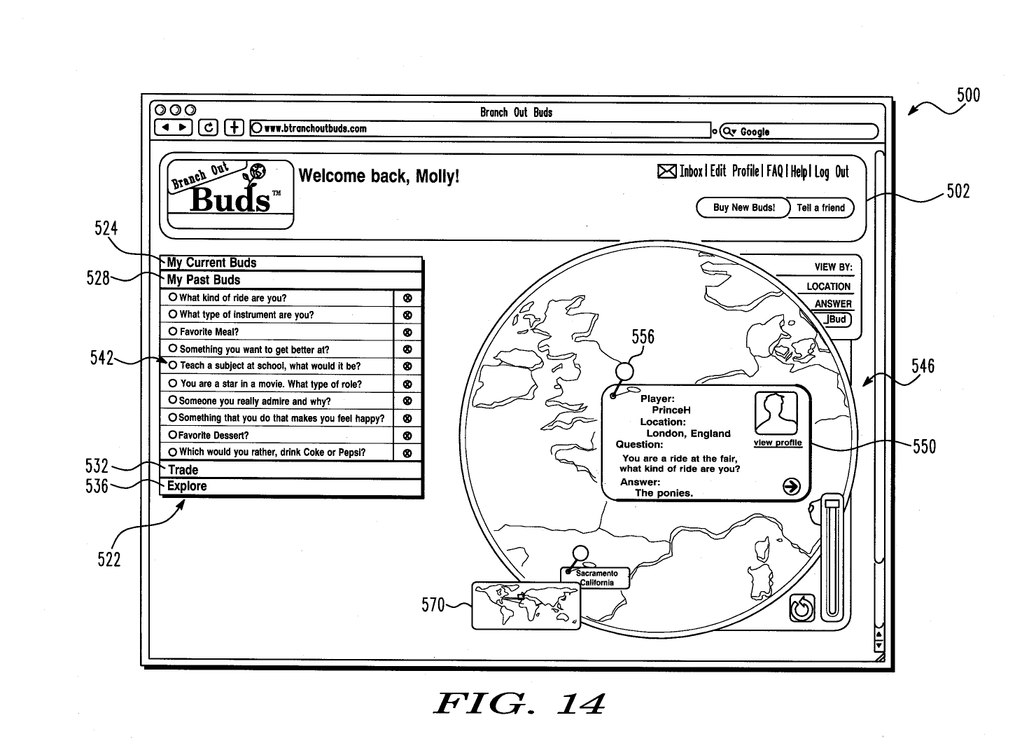

The participant can click on the visual representation of one of the current or past locations of each Bud to see and access the information that relates to Bud or the participant of the Bud. Upon clicking on the visual representation, a graphical image may appear to provide more information about the Bud holder as well as the question, topic, etc. associated with the Bud. For instance, a graphical image 550 similar to that shown in FIG. 14 on web page 500 may be displayed. It should be appreciated that the geographic locations of the tokens may be distinguished from their immediate locations by any other suitable visual or informative means; thus, the use of a rotating globe image should not be seen as limiting the scope of the present disclosure.

Referring back to the web page 400 of FIG. 13, the rotatable globe image 446 may rotate a virtual 360° constantly unless the participant activates a pause/play button 454 adjacent to the globe image 446. In this manner, the globe image 446 constantly displays Buds located around the world. The rotatable globe image 446 can also be zoomed in or out with a toggle button 474, and a smaller graphical image 470 depicting the world may also be shown near the rotating globe to give a bigger picture view of the Bud locations and the location currently being viewed. Furthermore, a graphical image 476 having active buttons therein may be located adjacent to the rotating globe image 446 to select a viewing preference for the globe image 446. For instance, buttons within the graphical image 476 may allow a participant to view the image by location, answer, or Bud. The rotatable globe image 446 is preferably shown on most of the web pages for the web site except for the login web page 200 and the web page 1300 displaying the “Bloom Count”, as will be described in more detail below.

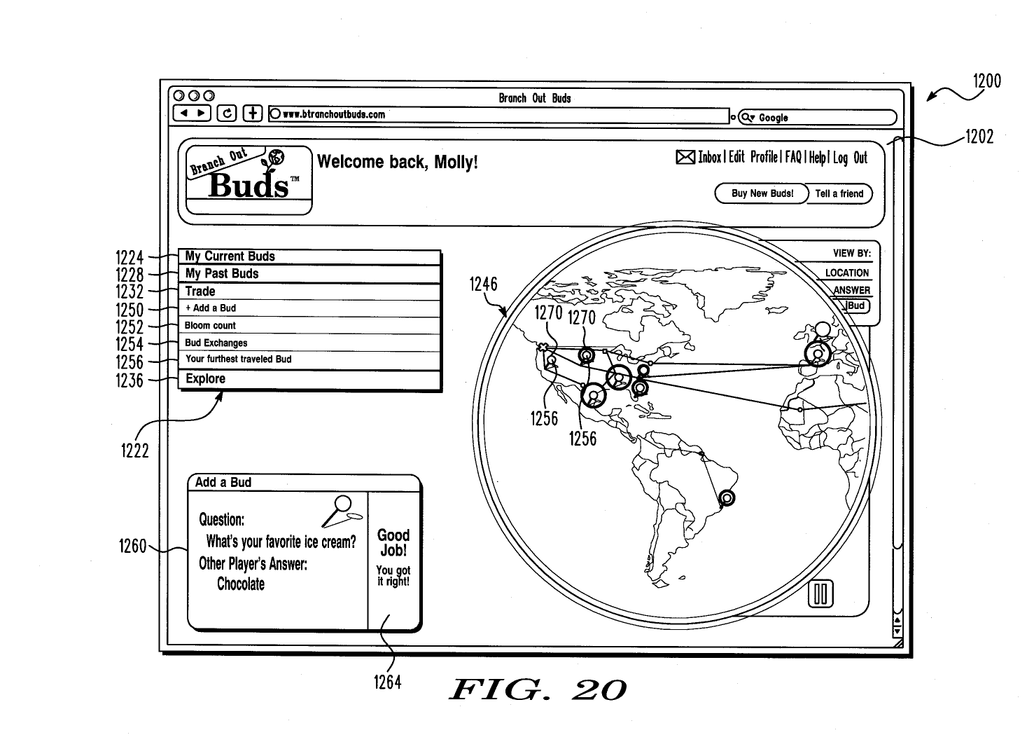

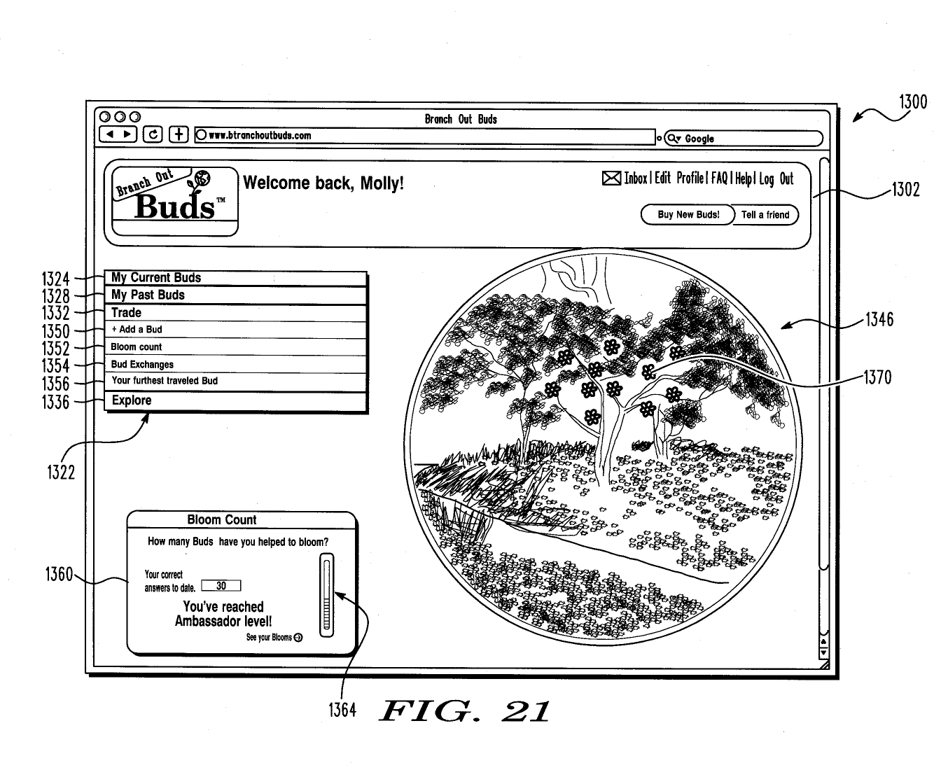

The images displayed on the rotatable globe image 446 may change when the participant activates different buttons and links on the website. For instance, when the participant selects a Bud button 440 on the drop down list for “My Current Buds” 424, a graphical image 450 including information pertaining to the Bud and/or participant (possible depending on the view selected) is shown on the globe “beneath” the map pin image 456 depicted in the geographic location of the participant. The graphical image 450 may include profile information for the participant, including the name and location of the participant, a photo, and an active link or button to view the participant's full profile. The graphical image 450 may also include an “X” image 452 located beneath a map pin image 456 to indicate that the Bud location is that of the participant. Moreover, as indicated by blocks 116 and 118 in FIG. 10B, when the participant activates certain buttons or links on the website, such as the “Who Shares your Answer” link 464 within the graphical image 460, the map pin images on the rotatable globe image may be highlighted with circles that flash or otherwise illuminate to further illustrate the number of Bud players who share the participant's answer (see the circles 1270 shown in the web page 1200 in FIG. 20). Other changes in the rotatable globe image 446 in response to participant input will be described in reference to the web pages depicted in FIGS. 14-28.

Referring to the web page 500 shown in FIG. 14, the participant may activate the “My Past Buds” button 528 to drop down a list of Bud buttons 542 that represent Buds previously in the participant's possession. As indicated at blocks 114 and 120 in FIGS. 10B and 10C, the participant can click on one of the Bud buttons 542 to view the current geographic location of the Bud and to learn more about the participant currently possessing the Bud. The location of the Bud is shown on the rotatable graphical image 546 with a graphical image 550 located beneath the map pin image 556 of the Bud's current location. The graphical image 550 may include information pertaining to the Bud, including the topic/question and answer, as well as information about the participant possessing the Bud. In this manner, the participant can see where his or her Bud has traveled, and can also learn more about another participant.

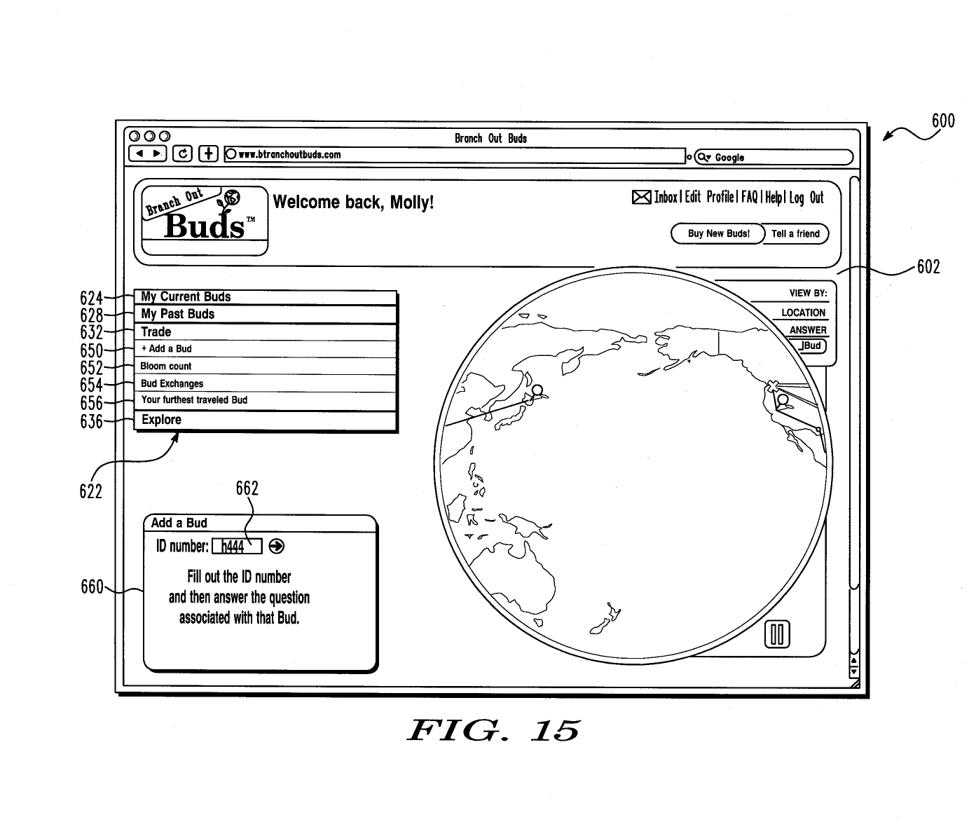

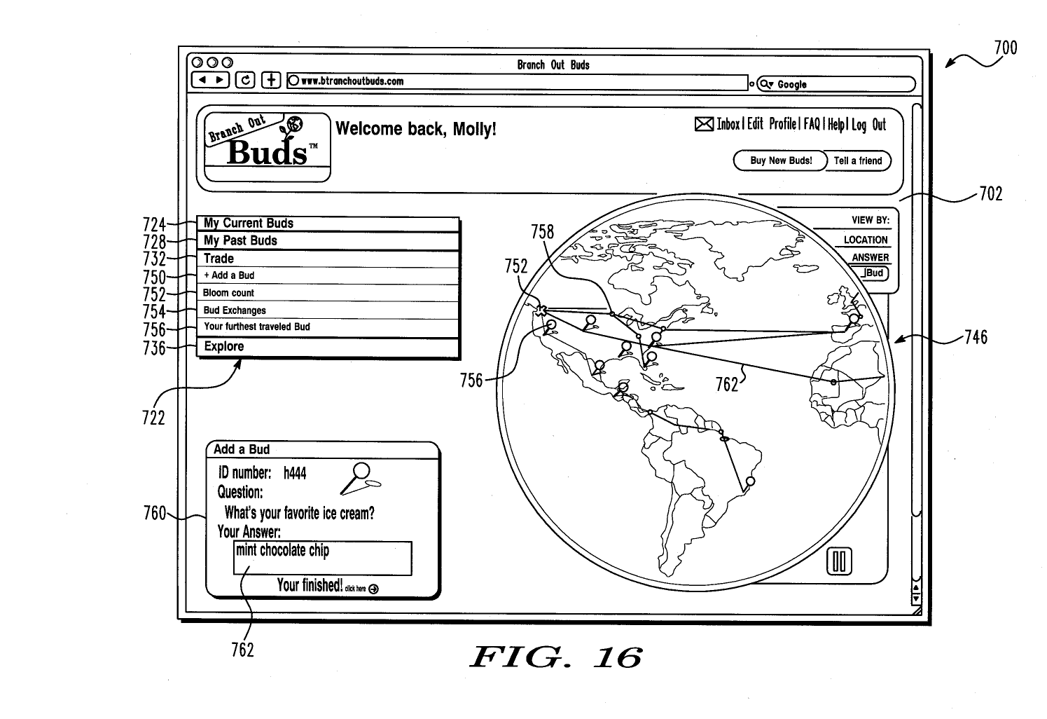

Referring to the web pages 600, 700, 800, 1000, 1100, and 1200 shown in FIGS. 15-20, respectively, the participant may activate the “Trade” menu item 632 in the menu 622 to drop down a list of Trade buttons for further exploring the website. For example, the participant may click on the “Add a Bud” button 650 to enter information pertaining to the Bud if it was just purchased or if it was received through an exchange with another participant. Upon activating the “Add a Bud” button 650, a graphical image 660 appears, which includes a text box 662 for entering the Bud identification number. The participant enters the Bud identification number, as indicated by block 110 in FIG. 10A, upon which the graphical image 760 appears, as shown in the web page 700 of FIG. 16.

The graphical image 760 displays a second text box 762 for entering the participant's answer or response to the question or topic associated with that specific Bud, as indicated by blocks 112 in FIG. 10A. In responding to the questions or topics, the participant responds based on his or her own feelings, preferences, abilities, beliefs and so on, and thereby encapsulates a defined piece of information that reflects something about the person himself or herself as an individual. This piece of information is recorded in the database 92 or 94 in association with the specific Bud. In short, after entry of the information, each Bud in the participant's current collection will have associated with it (1) a particular question or topic of a type that is answerable by all participants, and (2) an answer to that question or topic that reflects a piece of information relating to the participant. Both these pieces of information (i.e., the question, topic, etc., and the answer) are contained within the database 92 or 94 for subsequent retrieval and viewing.

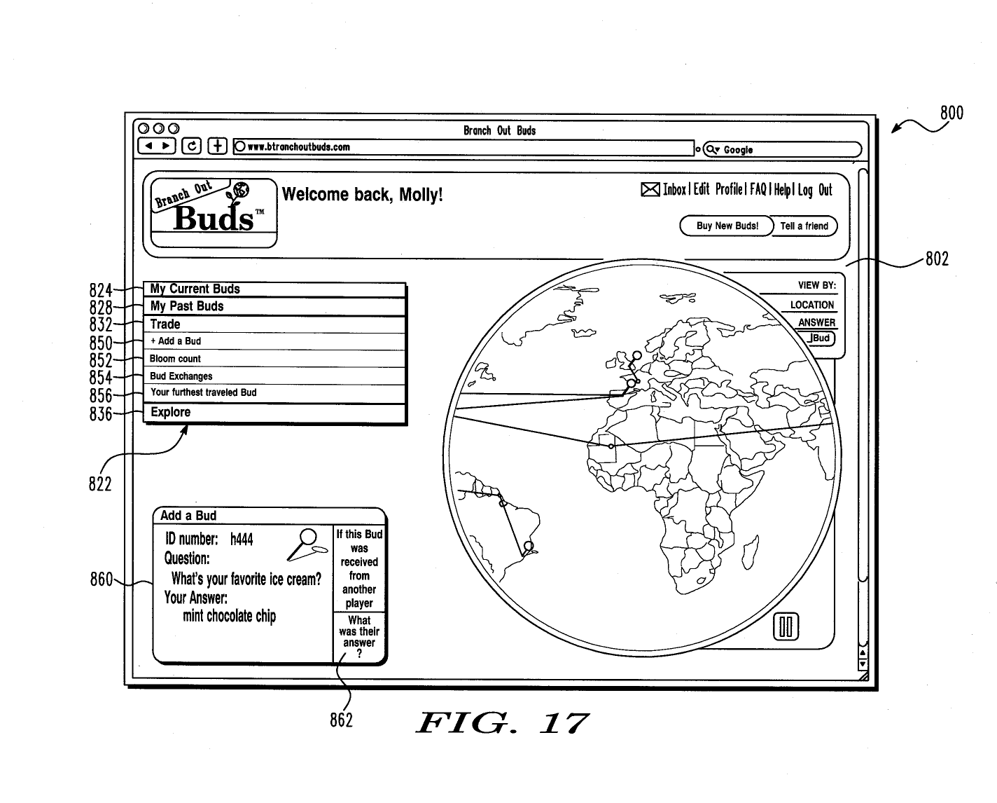

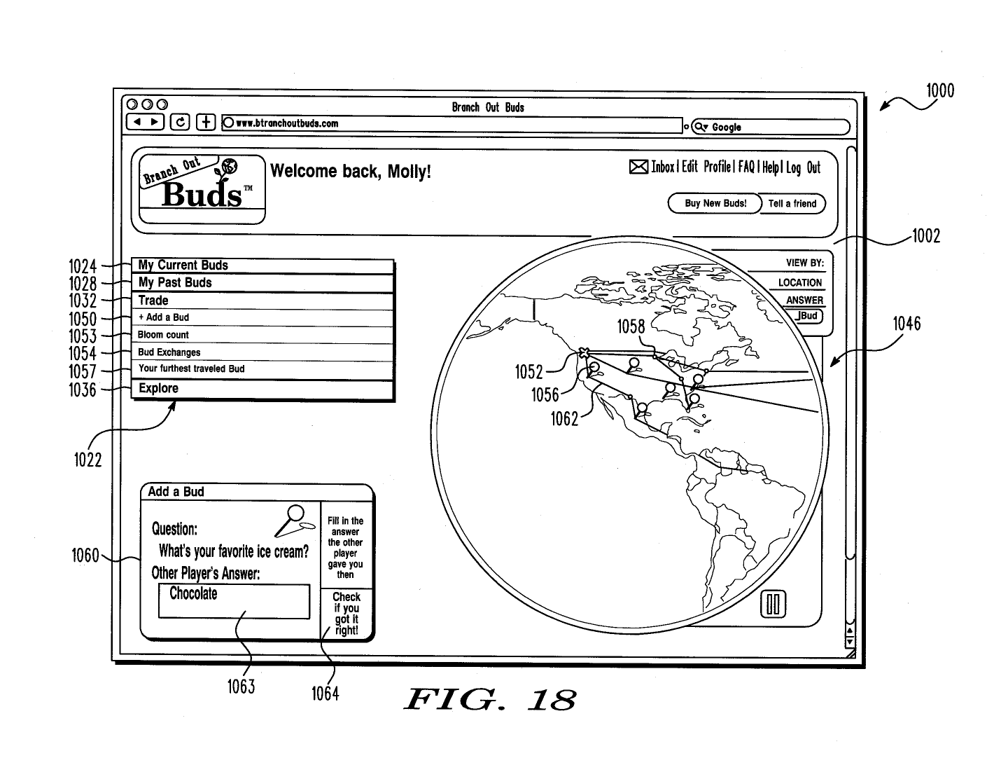

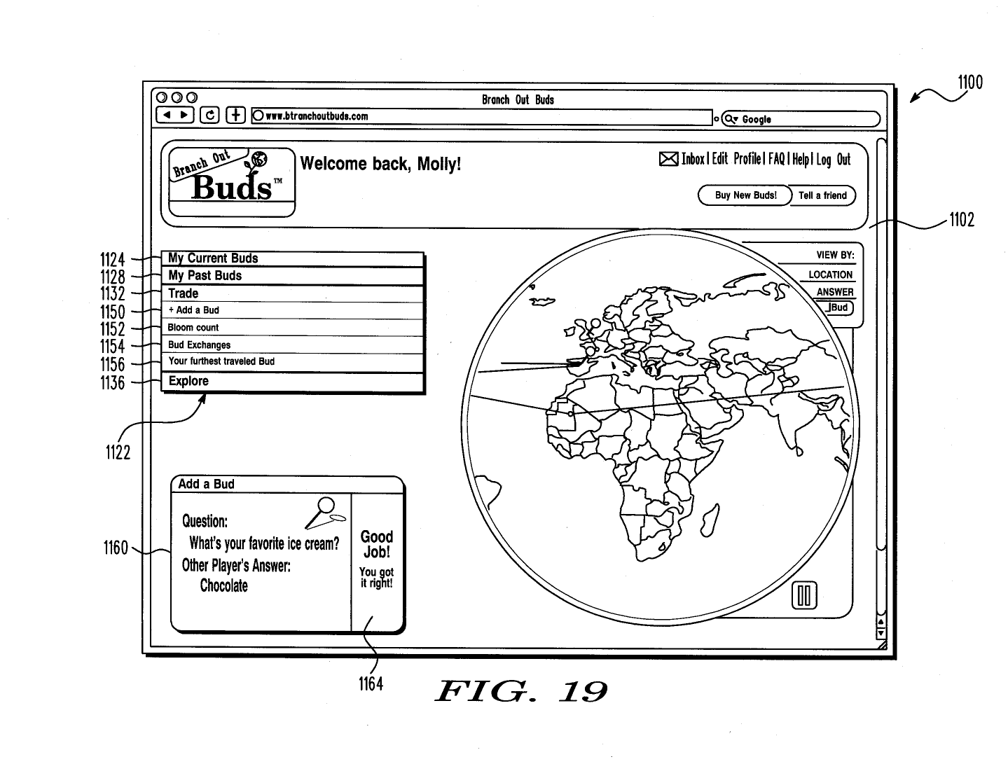

Upon entering his or her response, as shown in FIG. 16, a graphical image 860 appears, as shown in the web page 800 of FIG. 17, which displays the participant's answer. If it happens that the “new” Bud being entered into the database by the participant was received from another participant, rather than being purchased, then the graphical image 860 also provides an active link “What was their answer?” 862 to allow the participant to enter the other participant's response and see if he or she is correct, as indicated by blocks 128 and 132 of FIG. 10B. The participant may click on link 862, upon which graphical image 1060 shown in the web page 1000 of FIG. 18 appears.

The graphical image 1060 includes a text box 1063 for entering the other participant's answer to the question or topic associated with the new Bud. The database application 86 correlates this answer with that previously entered answer by the gifting participant, and upon clicking on an active link “Check if you got it right” 1064 within graphical image 1060, validation and possible award is provided in response to a correct entry, as shown in the graphical image 1164 of web page 1100 of FIG. 19. Referring to the web page 1200 shown in FIG. 20, one or more map pin images 1256 may be highlighted with a flashing circle 1270 upon the entry of a correct answer to show the other participants having the same answer, to highlight the previous owner of the Bud, etc. Moreover, a clapping audio sound or any other suitable noise may sound to congratulate the participant on the entry of a correct answer.

Referring to the web page 1300 of FIG. 21, the participant may activate the “Bloom Count” menu item button 1352 to display a graphical image 1360 that indicates the number of correct entered answers to date, as indicated by block 168 of FIG. 10C. Upon reaching a certain level of correct entered answers, the graphical image 1360 may further display a meter, indicator, or other suitable image indicating the level reached as well as a textual message congratulating the participant on the level reached (i.e. “You've reached Ambassador level!”). Further upon activating the “Bloom Count” menu item button 1352, a graphical image 1346 of a tree showing bloom images 1370 corresponding to the bloom count may also be shown. In such an instance, the rotatable globe image is not shown.

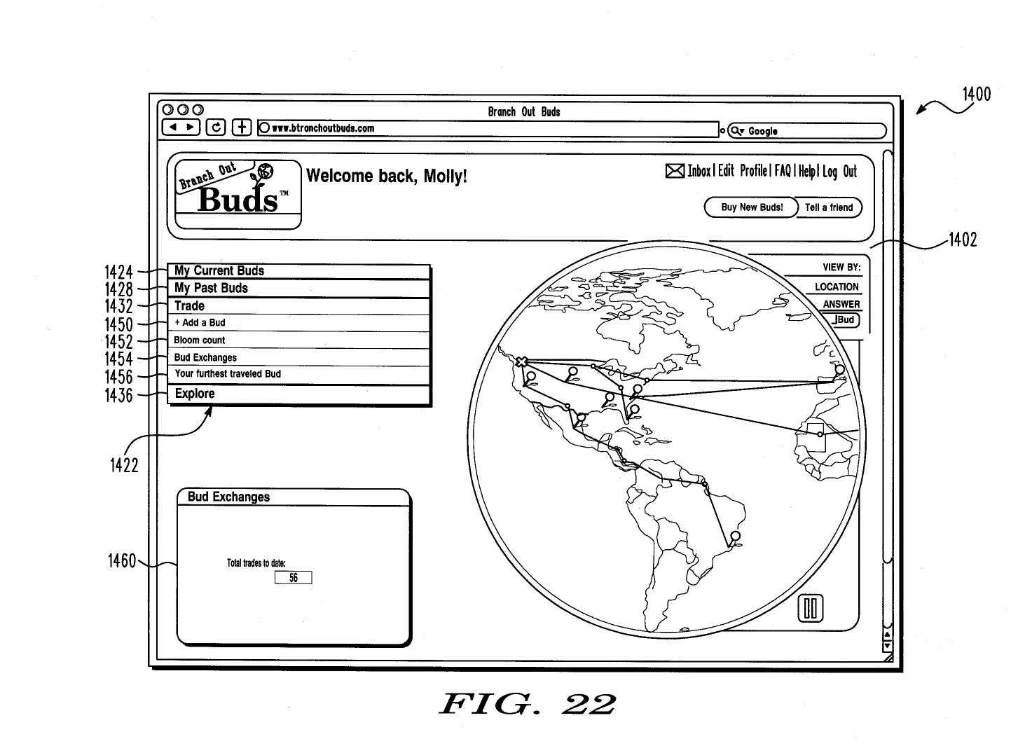

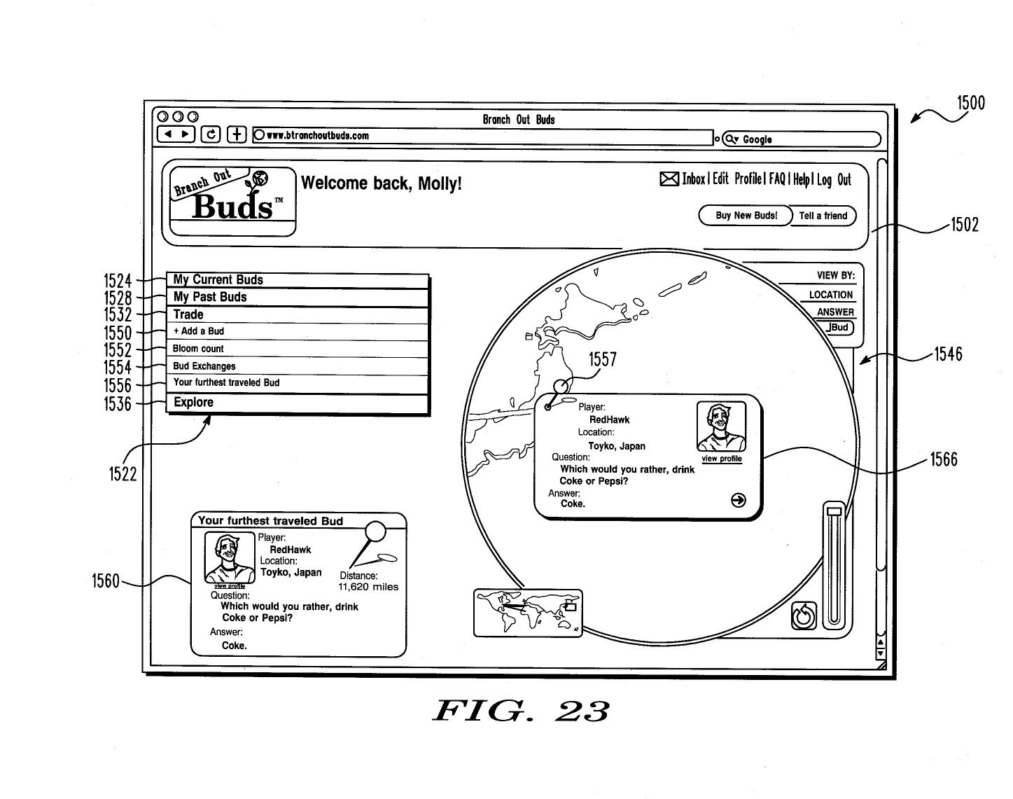

Referring to the web page 1400 of FIG. 22, the participant may activate the “Bud Exchanges” menu item button 1454 to display a graphical image 1460 that indicates the total number of Buds that they have traded with other participants to date, as indicated by block 172 of FIG. 10C.

Referring to the web page 1500 shown in FIG. 23, the participant may activate the “Your furthest traveled Bud” menu item button 1556 to display a graphical image 1560 that provides information about the participant's Bud on the basis of distance traveled, such as cumulative distance traveled or distance from the participant's current location, as indicated by block 176 of FIG. 10C. The distance can be calculated from the geographic locations entered by each of the participants who exchanged the tokens, using a conventional mileage calculator of the type known to those skilled in the relevant art. For example, the graphical image 1560 may include text indicating the name and location of the participant currently possessing the Bud, the link to the profile of that participant, the question and answer associated with the Bud, and the distance traveled. A similar graphical image 1566 may also be displayed on the rotatable globe image 1546 beneath the map pin image 1557 shown in the location of the Bud, similar to the described above with reference to images 450 and 550 shown on web page 400 and 500, respectively.

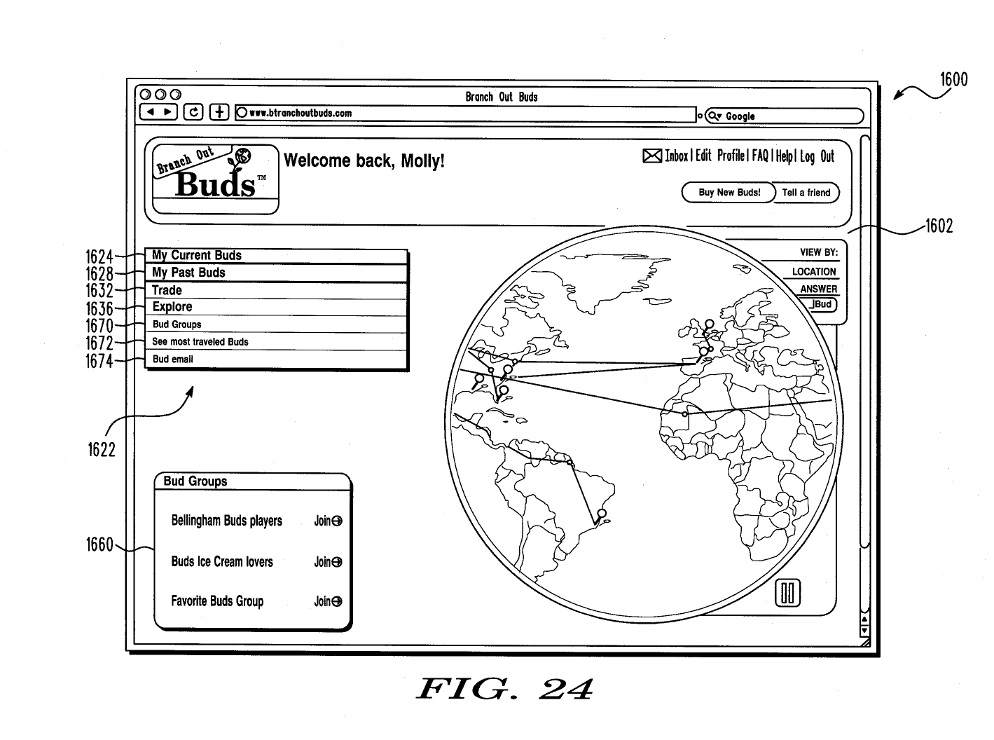

Referring to the web page 1600 shown in FIG. 24, the participant may activate the “Explore” menu item 1636 in the menu 1622 to drop down a list of Explore buttons for further exploring the website. The participant may activate a menu item button “Bud Groups” 1670 to view the Buds by groups, as shown in graphical image 1660 and indicated by block 156 in FIG. 10C. This information may be assembled from the information that has been associated with the Buds by present and/or past holders. For example, the graphical image 1660 may indicate groups of interest that have been grouped geographically (e.g., showing those participants who are located in a particular geographic region or location, such as a city), by a particular interest associated with one of the questions (e.g., ice cream flavors), or by favorites as defined by the participant.

The participant may join or learn more about each Bud group displayed in the graphical image 1660 by activating a link for that Bud group. Upon joining the group, the participant may learn more about the topic associated with that group through information entered into the website by other participants in the group. For instance, the participant may view videos posted by participants pertaining the question or topic of that group, as indicated by block 160 of FIG. 10C. As another example, the participant may learn where to get ice cream, as suggested by other participants, if the topic associated with the group is “favorite ice cream,” as indicated by block 164 of FIG. 10C.

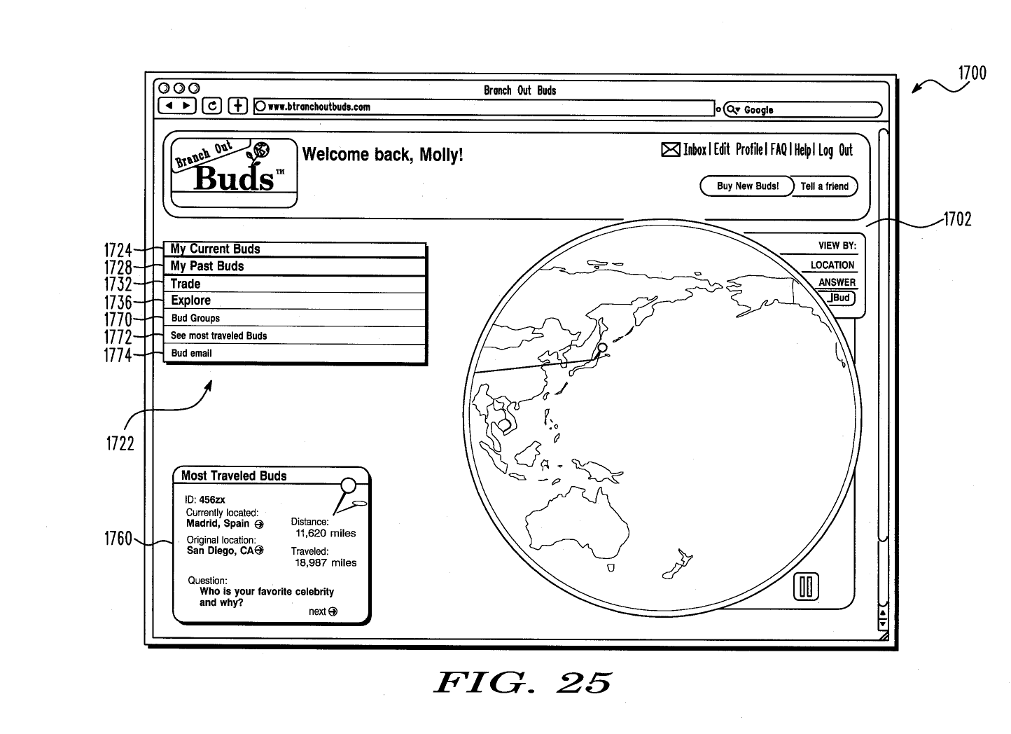

Referring to the web page 1700 of FIG. 25, the participant may activate the menu item “See most traveled Buds” 1772 to display a graphical image 1760 providing information about the Buds of participants that have traveled the furthest, as indicated by blocks 140 and 144 of FIG. 10B. The graphical image 1760 may include information about a Bud on the basis of distance traveled, such as cumulative distance traveled or furthest distance from the originator. Other information may be included, such as the Bud identification number, the original location, the current geographic distance of the Bud from the viewing participant, the question or topic associated with the Bud, etc.

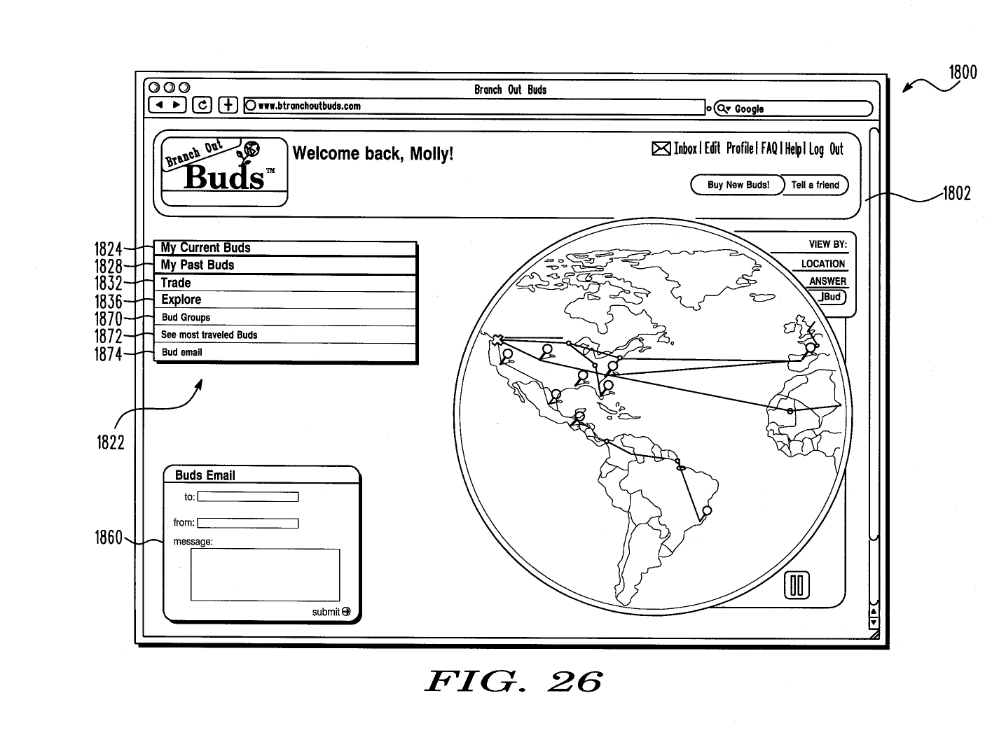

Referring to the web page 1800 displayed in FIG. 26, the participant may activate the menu item “Buds email” 1874, as indicated by block 152 in FIG. 10C, to display a graphical image 1860 that includes text boxes for entering the email address or name of one or more receiving participants, the name of the participant originating the message, and a message to the receiving participant. The Buds email enables direct communication between participants to further the growth of the participant's network with other participant's on the website.

It should be appreciated that other features not shown may also be provided on the exemplary website described above to further the interaction between participants, to enhance learning about different topics and regions of the world, to create a more user-friendly experience, etc. For instance, the rotatable globe images described above may further enable the participant to learn about certain regions and cultures by clicking on a region of the globe, as indicated by block 148. The website may also provide one or more web pages having a link for viewing the most common answers to Bud questions or topics, as indicated by blocks 180 and 136 of FIG. 10B, or a text box for entering the Bud identification number to see where it originated and where it has traveled, as indicated by block 124 in FIG. 10B. In addition, websites having customized web pages may be created for certain groups or organizations having customized tokens, as described above.

As yet another example, the Buds may be used for promotional or advertising of items associated with the Bud topics. For instance, when clicking on a map pin image associated with a Bud, clicking on a Bud button, etc., the participant may receive a burst of inspiration, quote, musical clip, etc., associated with Bud. The website may further provide the capabilities of purchasing and downloading the full version of the song, book, movie, etc. associated with that burst of inspiration, quote, musical clip, etc. through an external website.

In addition, the supplier of the website may provide an application for accessing the website via a handheld computer, cell phone, etc., wherein the application is suitable for updating the participant's status with respect to the participant's profile, exchanged Buds, etc. For instance, upon exchanging a Bud with another participant, the participant may be able to access the handheld computer application to instantly enter the answer or response of the other participant for the exchanged Bud. Moreover, if the Buds are RFID tokens or virtual tokens, the handheld device may automatically “Add a Bud” for the participant when the RFID reader on the handheld device scans the exchanged token or the virtual tokens are exchanged.

Thus, it should be appreciated that many other features may be added to the website described above to further the expansion of communication between participants and to further allow the participant to learn. Using the exemplary website in the above-described manner enables each participant to meet and learn more about other participants across geographical and cultural boundaries. Moreover, unlike numerous prior communications via the Internet, each entry is based upon a physical or virtual exchange of tokens that represent a real world, face-to-face communication between two people. Hence, the present disclosure represents a melding of electronic and direct interpersonal communication that provides an enhanced potential for establishing true understanding among all participants.

While illustrative embodiments have been illustrated and described, it will be appreciated that various changes can be made therein without departing from the spirit and scope of the present disclosure.

The embodiments of the present disclosure in which an exclusive property or privilege is claimed are defined as follows:

1. A method for facilitating communication between participants, the method comprising:
(a) providing a plurality of individually-identifiable tokens to at least first and second participants;
(b) associating a unique question with each token;
(c) transferring a first token from the first participant to the second participant;
(d) asking the second participant the question that is associated with the first token;
(e) transferring a second token from the second participant to the first participant;
(f) asking the first participant the question that is associated with the second token; and
(g) recording the answers that are provided by the first and second participants in response to the questions associated with the first and second tokens.

2. The method of claim 1, wherein each token is visible to other participants.

3. The method of claim 2, wherein each token is detachably securable to a wearable article.

4. The method of claim 1, wherein the question associated with each token is constructed to elicit a predetermined item of personal information from a participant.

5. The method of claim 1, wherein each token includes a unique identification number that corresponds to the unique question.

6. The method of claim 1, further comprising providing a means for accessing the unique question associated with the token.

7. The method of claim 1, wherein the token is a device containing a microchip that includes circuitry to wirelessly communicate with a token reader.

8. The method of claim 1, wherein the token is a packet of information stored in a database accessible by a handheld computer device.

9. The method of claim 8, wherein the tokens are wirelessly exchanged between handheld computer devices.

10. The method of claim 8, further comprising providing a network location to the participants for facilitating the recording and storage of answers provided by the first and second participants.

11. The method of claim 8, wherein providing a network location to the participants for facilitating the recording and storage of answers provided by the first and second participants includes generating web pages that allow the participant to:
(a) input a unique identifier in association with a token;
(b) input a participant's response to the question associated with the token;
(c) activate a button to retrieve information pertaining to the token; and
(d) activate a button to retrieve information pertaining to a token previously in the participant's possession.

12. A method for facilitating communication between participants, the method comprising:
(a) providing a plurality of individually-identifiable tokens to at least first and second participants;
(b) associating a unique question with each token;
(c) transferring a first token from the first participant to the second participant;
(d) asking the second participant the question that is associated with the first token;
(e) transferring a second token from the second participant to the first participant;
(f) asking the first participant the question that is associated with the second token; and
(g) providing a network location for generating web pages, wherein a participant may access the web pages to record and store answers provided by the first and second participants in response to the questions associated with the first and second tokens.

13. The method of claim 12, wherein each token is visible to other participants.

14. The method of claim 12, further comprising providing a means for accessing the unique question associated with the token.

15. The method of claim 12, wherein the token is a device containing a microchip that includes circuitry to wirelessly communicate with a token reader.

16. The method of claim 12, wherein the token is a packet of information stored in a database accessible by a handheld computer device.

17. The method of claim 16, wherein the tokens are wirelessly exchanged between handheld computer devices.

18. The method of claim 8, wherein providing a network location for generating web pages allows a participant to:
(a) input a unique identifier in association with a token;
(b) input a participant's response to the question associated with the token;
(c) activate a button to retrieve information pertaining to the token; and
(d) activate a button to retrieve information pertaining to a token previously in the participant's possession.

19. The method of claim 18, wherein the information pertaining to the token may include the geographical location of the token, the name of the participant currently possessing the token, and the distance the token has traveled between participants.

20. The method of claim 12, wherein providing a network location for generating web pages allows a participant to view on a graphical image a world map displaying the location and path of travel of each token previously in the participant's possession.
